(19) United States
(12) Patent Application Publication
(10) Pub. No.: US 2003/0060993 A1
(43) Pub. Date: Mar. 27, 2003

(54) Dynamic performance measures

(75) Inventors: Melanie Russell, Foxboro, MA (US); Fayyaz Hussain, Mandsfield, MA (US)

Correspondence Address: FOLEY, HOAG & ELIOT, LLP, PATENT GROUP, ONE POST OFFICE SQUARE, BOSTON, MA, 02109, US

(73) Assignee: Invensys Systems, Inc.

(21) Appl. No.: 09/846,899

(22) Filed: May 1, 2001

Related U.S. Application Data
(60) Provisional application No. 60/235,491, filed on Sep. 26, 2000.

(51) Int. Cl. G06F 19/00

(52) U.S. Cl. 702/84

(57) ABSTRACT

Methods and systems for creating dynamic performance measures (DPMs) for a cement production system. In an embodiment, clinker production and finish mill production can be optimized by aggregating sensor measurements from clinker production and finish mill production processes, and determining measures in the form of DPMs related to the productivity and cost of the clinker production and finish mill production. The DPMs can be provided to a display that can be viewed by manufacturing or other personnel. Control decisions can be made to change the clinker production and/or finish mill production processes while the results of such changes can be reflected in real-time on the DPM displays.

### BACKGROUND OF THE INVENTION

(1) Field of the Invention

The present invention relates generally to process control indicators and more particularly to real-time indicators for improved performance process control.

(2) Description of the Prior Art

In a process plant, various processes are employed to produce amounts of a desired product. Traditional methods to measure general performance of manufacturing operations of a certain product include counting the amount of product produced over a certain period of time, and from that amount, calculating a cost per unit product. The cost per unit product is typically based on a standard cost function that is associated with the operation, often developed at the beginning of a fiscal time period, and utilized throughout that period. The cost per unit product is also often reported to manufacturing management to evaluate manufacturing performance, and often serves as a primary measure of manufacturing performance.

One disadvantage of measuring manufacturing performance by cost per unit product is the equal distribution and allocation of plant costs to each product or product line in the determination of cost per unit product. Most costs in a manufacturing plant are not directly assignable to a product or product line, and therefore costs must be allocated as a function of other factors that usually have more to do with the perceived performance of the manufacturing operation than the actually occurring manufacturing practices.

A second disadvantage of measuring manufacturing performance by cost per unit product is that a considerable percentage of the costs in a manufacturing plant for calculating the cost per unit product, are not within the scope of manufacturing's authority; therefore, the performance measurement of cost per unit product leads to a “volume base” manufacturing approach that may not properly satisfy market and corporate requirements.

Another disadvantage is that the calculation to determine cost per unit product is a function of the amount of each product or product line produced, and this calculation is not sensitive to problems incurred in the producing a specific product. For example, if a bad batch of a given product is produced and discarded, a standard allocation algorithm cannot assign the costs associated with that batch to the specific product, and the costs are allocated to all products.

Other approaches to measuring manufacturing performance involve non-cost/non-financial measurements and include measurements of quality, delivery integrity and customer satisfaction. These approaches are generally directed to the discrete manufacturing industry and involve collecting information and displaying results in a traditional daily, weekly, or monthly report format. Such approaches do not provide timely measurements to allow operations personnel to improve the process on which the measurements were made.

There is currently not any sufficient systems or methods for generating timely measurements of manufacturing systems operations in the cement industry.

What is needed are methods and systems that allow cement industry manufacturing systems personnel to measure manufacturing processes to improve plant operations performance.

### SUMMARY OF THE INVENTION

The systems and methods disclosed herein provide a real-time (dynamic), sensor-based performance control apparatus that can be utilized in a cement production process. The control apparatus can employ a multiplicity of sensors and a computer processor for providing a real-time indication of operating performance from sensor signals. Performance can be indicated in terms of quality of generated products, cost of production, down-time, yield, and/or production.

Sensors can provide signals indicative of current state of a respective process. A digital processor assembly can be coupled to the sensors to receive the sensor signals. A computer can support the digital processor to determine, from the sensor signals, a quantitative measurement of current performance of the manufacturing operations based on current operation of at least one process. For example, the computer can calculate production cost as a function of sensed current amounts of resources used, and calculate quantity of production as a function of sensed rate of operation of certain processes.

The computer can further provide screen views displayed on a video display coupled to the digital processor assembly. The screen views can display indications of the determined measurement of current performance of manufacturing operations with respect to a predetermined target performance measurement. Subsequent operator adjustment through the control apparatus that is coupled to the process, in accordance with the indications in the screen views, can cause states of the process to approach operation that provides a predetermined target performance of the manufacturing operations.

Along with screen view displays, the computer can provide audible and/or visible alarms in accordance with determined performance measurements. The alarms can be coupled to the digital processor assembly. For example, the computer can provide an alarm when certain criteria are satisfied by a process and/or by determined performance. For example, the computer can enable an alarm when a determined performance measurement based on current cost of production exceeds a predefined threshold, and/or when determined performance measurement based on quality is outside a predefined range.

In accordance with the methods and systems herein related to a cement processing operation, sensors can include temperature sensors, weight sensors, pressure sensors, etc.

In one embodiment, the digital processor assembly can include processor modules. Different sensors can be coupled to the different processor modules. Processor modules can have an object manager to transmit respective sensor signals to a computer upon request by the computer. Sensor signals can be formed of a named series of data points stored in a memory area, and object managers can enable access of data points by name instead of memory location.

The computer can be coupled to an external system for receiving pertinent predefined measurements of target performance. A control apparatus can be coupled to the digital processor assembly. Additionally, a processor member supported by the digital processor assembly can receive working data from the computer and store the working data on a common time-line in a global database for general access. The working data can include determined performance measurements, predetermined target measurements, indications of sensed states of process means, operator adjustments, and predefined thresholds for alarms. In one embodiment, the database can be a relational database accessible globally at subsequent times as desired for different applications.

In an embodiment wherein the methods and system disclosed herein can be applied to generate an advanced control solution for a cement production system, the systems and methods can be applied to a wet cement manufacturing process. In another embodiment, the systems and methods can be applied to a dry cement manufacturing process. In a cement production system, sensors can provide measurements that can be related to the efficiency of a kiln and a finishing mill that can be integral to cement production quantity, quality, and cost. The sensor measurements can be related to kiln and finishing mill cost and production to allow manufacturing, engineering, operations, or other personnel to alter processes and adjust the kiln and finishing mill cost and production measures accordingly.

In an embodiment, kiln production can be measured and monitored as a function of feed to the kiln less dust loss. Kiln cost can thereafter be computed as a function of kiln production. Alternately, finish mill can measure throughput as a function of the fresh feed produced in tons per hour. Finish mill production costs can be computed as a function of the finish mill throughput and energy costs.

Other objects and advantages of the invention will become obvious hereinafter in the specification and drawings.

### BRIEF DESCRIPTION OF THE DRAWINGS

A more complete understanding of the invention and many of the attendant advantages thereto will be readily appreciated as the same becomes better understood by reference to the following detailed description when considered in conjunction with the accompanying drawings, wherein like reference numerals refer to like parts and wherein:

FIG. 1 is a description of a cement production process as is commonly known in the art;

FIG. 2 is an illustration of Dynamic Performance Measures (DPMs) for the cement production process of FIG. 1;

FIG. 3A, 3B, 3C, and 3D present other displays that can be generated from the DPM data of FIG. 2; and, FIG. 4 provides an illustrative system for one embodiment of the invention that utilizes the I/A Series system.

### DESCRIPTION OF ILLUSTRATED EMBODIMENTS

To provide an overall understanding of the invention, certain illustrative embodiments will now be described; however, it will be understood by one of ordinary skill in the art that the methods and systems described herein can be adapted and modified to provide methods and systems for other suitable applications and that other additions and modifications can be made to the invention without departing from the scope hereof.

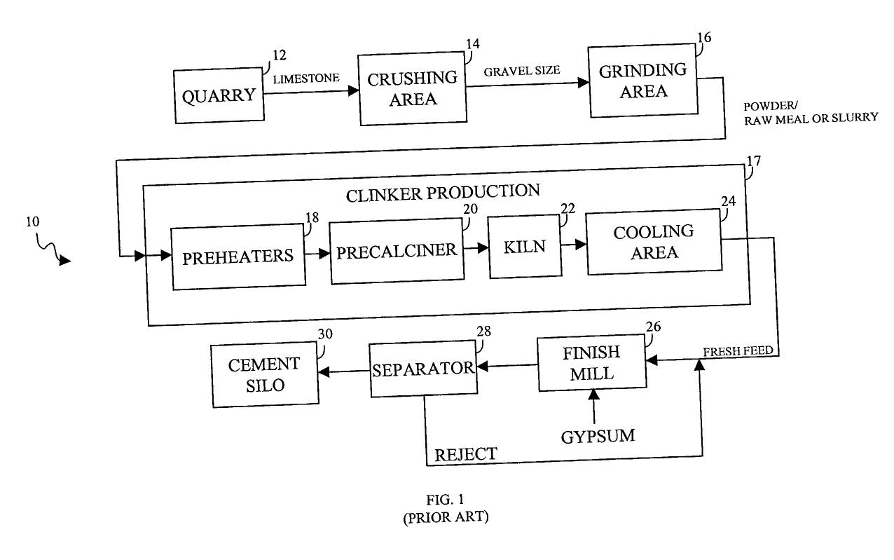

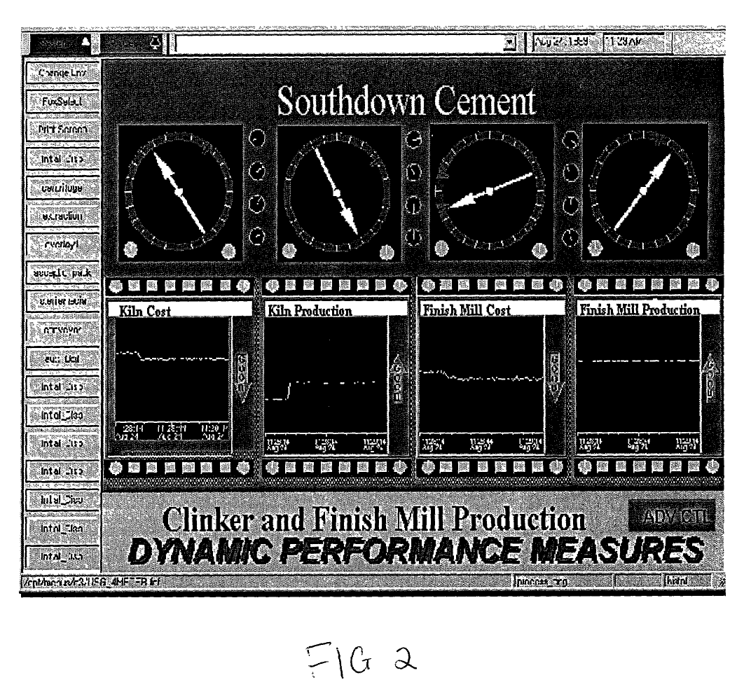

FIG. 1 shows an illustrative block diagram of a cement product process 10 for a dry production process. As FIG. 1 indicates, limestone from a quarry 12 can be presented to a crushing area 14 where it can be reduced to gravel size pieces for presentation to a grinding area 16. The grinding area 16 blends raw materials in the proper proportions and grinds them into a powder than can otherwise be known as Raw Meal. In an alternate embodiment not shown in FIG. 1 and known as a wet production process, water can be added to the raw feed during the grinding process 16 to create a mixture called slurry. For the purposes of the discussion herein, the FIG. 1 system shall be understood to represent the well-known wet and dry processes, and in accordance therewith, Raw Meal shall be understood to include slurry. Returning to process referenced by FIG. 1, the Raw Meal is presented to the Clinker Production area 17 that can include a four stage Preheater 18, a Precalciner 20, a Kiln 22, and a Cooling Area 24, although those with ordinary skill in the art will recognize that the illustrated Clinker Production area 17 is provided for illustration and not limitation, and fewer, more, and/or substitute components of a Clinker Production area 17 can be provided without departing from the scope of the invention. The illustrated Preheaters 18 are vertical cyclone chambers through which the Raw Meal passes. The Precalciner 20 accepts the Raw Meal from the last stage of the Preheaters 18, and performs a partial calcination process by introducing fuel, thereby removing carbon dioxide. In the illustrated system, the fuel is coal, although those with ordinary skill in the art will recognize that other fuels can be used for the calcination process, and other systems may use Pre-heaters with other numbers of stages. After the passing through the Precalciner 20, the material previously known as Raw Meal and heretofore referred to as “the material” moves into the kiln 22, wherein remaining carbon dioxide is removed and the intense heat begins to trigger chemical reactions that turn the material, now precalcined, into clinker. In the illustrated kiln 22, the material temperature can reach twenty-seven hundred degrees towards the discharge end of the kiln 22, wherein the material begins to form nodules that can otherwise be termed clinker. In the FIG. 1 system 10, the clinker retreats to the cooling area 24 where fans force cool air over the clinker. In the illustrated system, the heat recovered from the cooled clinker can be partially returned to the kiln 22 as secondary air to assist the primary combustion.

In a finish mill 26, clinker from the cooling area 24, known otherwise as fresh feed, can be mixed with gypsum, slag, rich limestone, etc., before being fed into a grinding mill that grinds the treated clinker into a very fine powder. A separator 28 can accept the fine powder from the finish mill 26 and distinguish between material that does and does not meet fineness requirements. Material meeting the fineness requirement can be stored in cement storage silos 30 for shipping at a later time, while material not satisfying the fineness requirement can be returned to the finish mill 26 as “reject” and combined with fresh feed from the cooling area.

From the process of FIG. 1, it can be shown that a critical part of the cement production process includes the making of clinker. For systems according to FIG. 1, a clinker factor can be computed and verified to satisfy a clinker production efficiency. For example, a clinker factor of fifty-six onehundredths can indicate that for every ton of material that enters the kiln 22, fifty-six one-hundredths of a ton of clinker is produced. Fuel rate and feed rate to the kiln can therefore be determined to be important factors to clinker production.

For the system of FIG. 1 wherein maximization of clinker production for minimal cost is desired, a dynamic performance measure (DPM) can be defined to maximize throughput of the clinker production area 17, increase clinker quality, measure burning efficiency, and optimize refractory life. DPMs are metrics that model performance measures in process manufacturing operations, wherein the metrics are derived from process instrumentation. DPMs can thus be calculated from a production process using real-time, preferably object-based process data to display results in real-time to operations, engineering, maintenance, and/or appropriate manufacturing or other personnel, as decision support tools for real-time plant operations. In an embodiment, the DPMs can be presented graphically, and the DPM results can be historized into a real-time database management system for later use, aggrandizement, and integration with other computer information systems of the manufacturing plant.

DPMs for a particular plant operation can be a function of the manufacturing strategy for that operation. The DPMs for one process or group thereof in one plant may not be appropriate for the same process of a similar but different plant. For example, if a manufacturing or process plant is production limited, primary measures can include yield or some other production-based statistic; but, if a manufacturing or process plant is not production limited, primary measures can be more resource-based. Developing DPMs therefore includes determining a manufacturing strategy, and translating that strategy to specific measurements that can assist in determining whether the strategy is successful, and this success can be measured on a process-byprocess basis.

Once specific measures are determined, sensor information to make the measures can be determined. In many manufacturing and process plants, the sensors to make the measures are already installed in the manufacturing or control process. In some cases, new sensors can be installed to complete the collection of sensor-based information to measure the manufacturing or process operations.

The sensor measurements can be input to a computer or other processing module. In an embodiment, the sensors can transmit a digital or analog signal to the computer that is equipped with appropriate input/output capability to receive the sensor-based information. The computer can convert, as necessary, the incoming sensor signals into digital values that can be formed into an input block that includes a collection of records or fields for sensor data. In an embodiment, a particular input block corresponds to a particular sensor. An input block can also provide general system access to the sensor data by name, where the global name is based on the name assigned to the input block. This data point or “object” value can be available to any application on the computer, or to other computers in a network to which the computer is connected, by specifying the name of any input block or the name of the field or record of interest in the input block.

Calculation algorithms can also be formulated as part of the DPM construction. The calculation algorithms can mathematically relate the sensor measurements to a measure of the manufacturing strategy. The calculation algorithms can also include targeted values, predetermined values, and comparisons between currently calculated values and the target values.

In an embodiment, an object oriented programming based block structure can be established for a computation algorithm. These algorithm blocks can be preprogrammed for DPMs that are frequently encountered, or they can be programmed for different applications. The sensor-based data provides the input to the algorithm blocks, and this can be accomplished by identifying in the algorithm block, an input block name and an input block parameter (field or record) of interest. The sensor data can therefore be input to the algorithm block and manipulated according to the mathematical relationships in the algorithm block.

The algorithm block output can be a global object that can be accessed by the computer or another computer in a network, for example, by specifying the name of the producing algorithm block. The output object values can be a basis for the DPMs of interest.

In an embodiment, in an algorithm block, the current overall performance of a manufacturing or plant operation can be computed as a function of the sensor measurements. The calculated performance can be compared to a targeted performance measure as stored in, for example, an algorithm block or in a historian database. The comparison results can be presented to a display object and/or a historical database.

Display objects and display templates can be constructed for standard presentations of the DPMs, and can include line graphs that depict the DPM value over a period of time (historized), an indication of the DPM target value, an indication of any pertinent alarm limits. In an embodiment, the x and y axes can be labeled for the application and include a directional indicator showing the direction of increasing performance. Display objects can be combined with other graphics to build an entire display template.

Subsequent to the building and displaying of the comparison results in various display objects, an operator/user can adjust controls and hence processes accordingly. The real-time display of the compared calculated performance and target performance in terms of production/resource factors of administration, enables operator adjustment of processes, and hence resource/production factors, immediately during subject manufacturing toward target performance, i.e., toward desired values of resource/production factors. These adjustments can be recorded in a historian database. A historian database can therefore include sensed states of processes, operator adjustments, calculated performance measurements, and predefined target measures.

Returning now to the generalized cement processing system shown in FIG. 1, wherein manufacturing strategies include the maximization of clinker production while minimizing cost, DPM calculation algorithms can be defined as follows:

Clinker Production=(feed to kiln - dust loss)*.56 tons/hour (1)

The “feed to kiln” can be either slurry or raw meal, depending upon the wet or dry process, respectively. The computation for clinker production of Equation (1) can also be interpreted and expressed as a computation for kiln production. Alternately, Clinker cost can be expressed as:

Cost per ton of Clinker=(Fixed Cost+Energy Cost+Fuel Cost+Raw Material Cost+Losses)/(Clinker Production) (2)

If it is assumed that Fixed Cost and Raw Material Cost are not variable and not subject to control by the operations or other management personnel, etc., Equation (2) can be reduced and expressed as a function of Equation (1) to represent the kiln cost per ton of clinker, or more simply, cost per ton of clinker:

Cost per ton of Clinker=(KWH*Cost of KWH)+(Coal feed rate*Cost of coal)+(Other fuel feed rate*Cost of other fuel))/((feed to kiln - dust loss)*.56 tons/hour)

Those with ordinary skill in the art will recognize that Equation (3) is computed with respect to tons, and therefore items such as “coal feed rate” and “other fuel feed rate” should be expressed in tons/hour. In Equation (3), other fuel feed rate are variable and controllable, while the costs of the respective quantities or measures (e.g., costs of KWH, coal, other fuel(s)) are not controllable and can be fixed or dictated by an outside source or vendor.

In an embodiment, waste fuels can supplement coal feed, wherein the cement manufacturer, etc., is paid to accept and include the waste fuels with the coal feed at the input to the kiln and/or precalciner. In an embodiment wherein waste fuels are utilized, the cost of per ton of clinker as provided in Equations (2) and (3) herein, can be modified by subtracting an amount equal to the waste fuel credit in tons per hour.

For the illustrative system of FIG. 1, the kiln sensors can provide measurements including kiln feed, temperature measurements at the input and output of the preheater stages, water content at the preheater stages, oxygen and carbonmonoxide, cooling fan rotation and power (current, voltage, etc.), coal feed and BTUS, secondary air temperature, cooler vent temperature, clinker temperature in the cooling area, oil flow, fan speed, damper, etc., and such measurements are provided for illustration and not limitation. Those with ordinary skill in the art will recognize that the invention herein is not limited to the sensors, the sensor arrangement, or the format of the sensor input or output. Any sensor or sensor measurement that can be incorporated into a clinker production factor or a cost per ton of clinker according to Equations (1) and (3) herein is within the scope of the invention. Additionally, system variables, including for example, stack particulates and residual carbonate, although not measured directly, can be inferred using a non-linear modeling technique based on neural networks. Multivariable control can be implemented to control the process (e.g., kiln) by comparing measured temperatures to theoretical or ideal temperatures and automatically making the necessary adjustments. For example, a multivariable control system such as the Connisseur System by Invensys Systems, Inc., can utilize neural networks and/or fuzzy logic, although the invention herein is not limited to such embodiments.

A second DPM can be provided for the Finish Mill 26 to maximize throughput, minimize energy consumption, and minimize recirculating load. For the Finish Mill 26, the following computational algorithms can be developed:

Finish Mill Throughput=fresh feed to finish mill(tons/hour) (4)

Referring to FIG. 1 with reference to Equation (4), the fresh feed to the Finish Mill 26 is the amount of clinker input to the finish mill. This fresh feed measurement does not include reject as shown in FIG. 1, and although the FIG. 1 system indicates that clinker from the kiln is input to the Finish Mill 26, it is not unusual for the fresh feed measurement to include clinker from sources other than the kiln (i.e., cement processors can purchase clinker from alternate sources).

Another algorithm relating to the Finish Mill 26 includes the cost of cement:

Cost per ton of cement=(Fixed Cost+Energy Cost+Raw Material Cost+Losses)/(Fresh Feed) (5)

Once again, by eliminating the non-variable Fixed Cost and Raw Material Cost from Equation (5), and incorporating Equation (4) into Equation (5), the Cost per ton of cement (“Finish Mill Cost”) can also be expressed as:

Cost per ton of cement=((KWH*Cost of KWH)+(Clinker Feed Rate*Cost of Clinker)+(Gypsum Feed Rate*Cost of Gypsum)+(Grinding Aide Feed Rate*Cost of Grinding Aide)/((Fresh Feed)−Reject). (6)

Once again, in equations (5) and (6), quantities are understood to be expressed in consistent units of tons/hour. Fixed Cost and Raw Material Cost are not subject to control, while Energy Cost (i.e., Clinker feed rate) and Losses (i.e., Grinding Aide feed rate) are variable and controllable by an operator, management personnel, etc. Similarly, the Gypsum feed rate is variable and controllable. Once again, costs of respective elements (e.g., costs of KWH, Gypsum, Grinding Aide) can be fixed by an outside source or vendor. The Cost of Clinker can be determined from Equation (3), and can be variable depending upon factors discussed previously in relation to Equation (3). The Clinker Feed Rate as indicated by Equation (6) represents the feed rate of Clinker to the Finish Mill 26 for the representative system of FIG. 1.

For example, in the illustrated finish mill, measurements can include feed at the input, reject at the input, energy, water content, power, temperature, etc. Those with ordinary skill in the art will recognize that the invention is not limited to these parameters or the sensors for measuring the same, and the invention includes any and all sensors and measurements that can contribute to the determination of the factors of equations (4) and (6) for the computation of the finish mill throughput and the cost per ton of cement. Once again, depending upon the computations of Equations (4) and (6), multivariable control can be employed to perform automatic adjustment of sensors, processes, etc., using mechanisms that can include neural networks, fuzzy logic, etc.

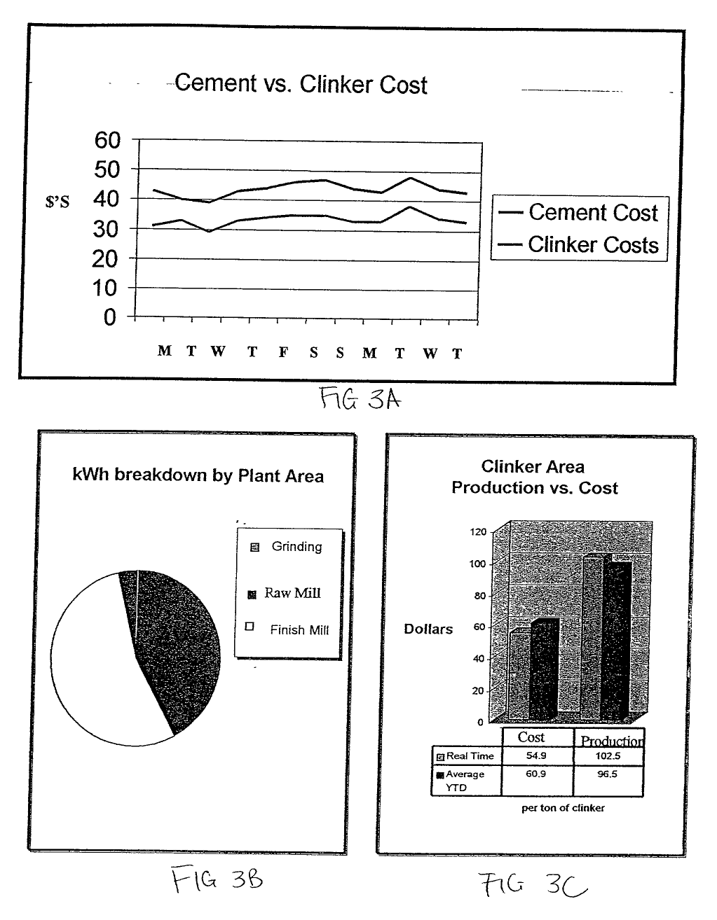

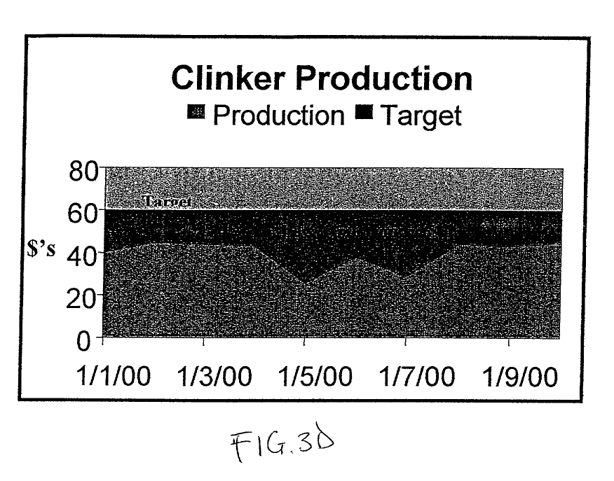

In an embodiment, Operator displays for the two DPMs can be provided on a single display, and can include metrics for clinker (i.e., kiln) production, clinker (i.e., kiln) cost, finish mill production, and finish mill cost. In another embodiment, multiple displays can be used. As FIG. 2 indicates, the four metrics can be provided as a function of time to an operator or other user. An operator or other user viewing the DPMs can determine instantaneously whether the production and/or cost goals are being satisfied. As indicated earlier, alarms can be used to alert the user to such conditions. Upon determining that the production and/or cost goals are not being satisfied, the user can determine whether one or more of the system variables requires modification or adjustment. As also indicated earlier, adjustments can be provided automatically using a multivariable controller that can implement fuzzy logic, neural networks, or other well-known techniques for classifying system conditions and/or automating a controlled response.

In an embodiment, existing or new sensors measuring the KWH of the kiln, the coal feed rate, fuel rate, feed, dust loss, and the KWH of the finish mill, the clinker feed rate, gypsum feed rate, grinding aide feed rate, fresh feed, and rejects, can provide data that can be formed into input blocks, submitted respectively to the computational algorithms as presented by equations (3) and (6) to develop one or more display objects as indicated in FIG. 2, for example. The presentation of such information in real-time can allow an operator, user, etc., to correlate a change in production or cost performance relative to one of the parameters. An operator, engineer, etc., can view the dashboard displays and make adjustments to the various parameters to determine how the Clinker Production and Finish Mill Production are affected as a function of cost. Those with ordinary skill in the art will recognize that the sensor measurements can be filtered and otherwise processed to eliminate noise or other undesired signals or signal components. Additionally, the processed or unprocessed sensor signals can be provided as input to a neural network or fuzzy logic to detect, for example, sensor failures and other conditions that can warrant intervention of engineering or operations personnel. Sensor failure conditions can also cause an alarm in an embodiment.

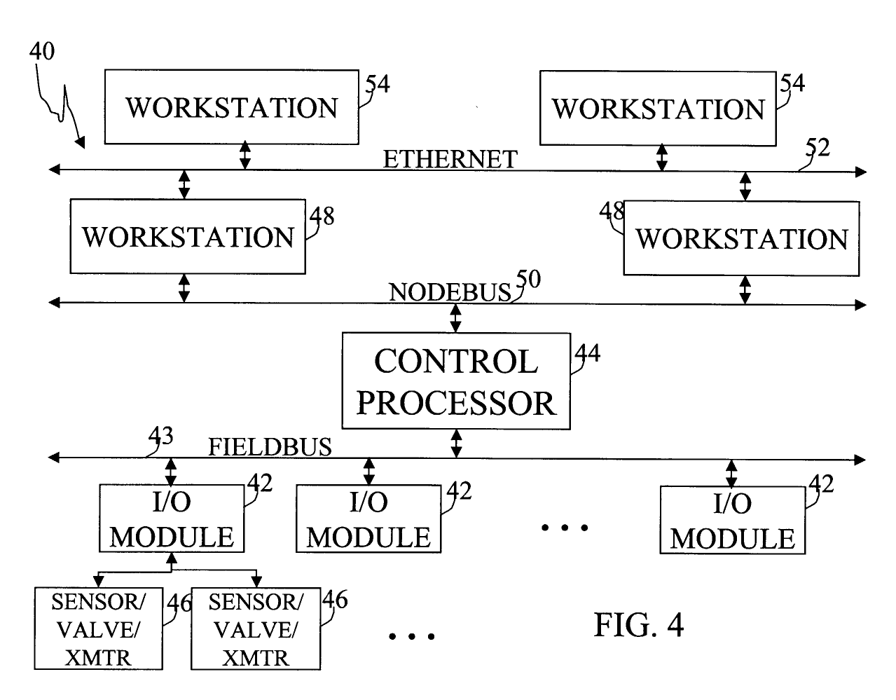

FIG. 3A shows an alternate method for displaying the information from the input blocks formed by the DPM process described herein based on the FIG. 1 system. FIG. 3A presents a daily display of Cement costs versus Clinker costs. FIG. 3B provides an analysis of KWH for the Grinding Area, Raw Mill, and Finish Mills. FIG. 3C illustrates Clinker Area Production versus Cost for real-time and Year-to-date, while FIG. 3D presents the difference, per day, in cost between a target cost and actual costs. Those with ordinary skill in the art will recognize that although the charts and figures of FIGS. 3A-3D were presented in particular display formats, the invention herein is neither limited to the information displayed, nor the format of the displayed information.

Referring now to FIG. 4, there is shown an illustrative system 40 that can be implemented in a cement production manufacturing process such as the system of FIG. 1, can further provide for implementation of DPMs as provided herein, and is known as the I/A Series ® system from Invensys Systems, Inc. As is well-known, the I/A Series ® system includes I/O Modules 42 such as the FBM44 modules, wherein the I/O Modules 42 can interface to a Fieldbus 43 and hence to a Control Processor 44 such as the I/A Series ® CP40B. Data from sensors 46 can be transferred to the I/O modules 42 using a transmitter, wherein the I/O Modules 42 can convert the sensor data to a format compatible with the Control Processor 44. In one embodiment of the system, the Control Processor 44 can include at least one processor that includes instructions for causing the processor to implement control algorithms. The Control Processor 44 can further include instructions for implementing DPMs such as those provided herein by Equations (1) through (6). As shown for the FIG. 4 system, the Control Processor 44 can interface to Workstations 48 through an I/A Series Nodebus 50 that can be compatible with Ethernet. The Workstations can be, for example, the I/A Series system AW51E that or any other system that provides the functionality described herein. The Workstations 48 can allow for the display of data such as that according to FIGS. 3A-3D herein to allow a processor engineer, manufacturing personnel, etc., to monitor and/or affect the controlled systems. The illustrated Workstations 48 can further interface to another Ethernet 52 that provides an interface to, for example, a corporate network that can be equipped with other Workstations 54, Personal Computers (PCs), etc., that can also have instructions for causing the display of DPM and/or other information to management or other entities. Historic information can also be provided to such systems 54 for local retrieval and analysis.

Returning to the Control Processor 44 of FIG. 4, depending upon the control algorithms, DPM computations, and any integration therein, the Control Processor 44 can be equipped to transfer control data to, for example, the valves or sensors 46 via the I/O Modules 42 to achieve specified control objectives. In one embodiment, the control objectives can be pre-programmed using a multivariable control system such as the Foxboro Connisseur system, however in other embodiments, manufacturing or other process system adjustments can be made manually or through the I/A Series Workstations 48.

One of several advantages of the present invention over the prior art is that dynamic performance measures are generated to relate sensor measurements in a cement processing system to identifiable management goals of balancing cement production and efficiency against production costs.

What has thus been described are methods and systems for creating dynamic performance measures (DPMs) for a cement production system. In an embodiment, clinker production and finish mill production can be optimized by aggregating sensor measurements from clinker production and finish mill production processes, and determining measures in the form of DPMs related to the productivity and cost of the clinker production and finish mill production. The DPMs can be provided to a display that can be viewed by manufacturing or other personnel. Control decisions can be made to change the clinker production and/or finish mill production processes while the results of such changes can be reflected in real-time on the DPM displays.

Although the present invention has been described relative to a specific embodiment thereof, it is not so limited. Obviously many modifications and variations of the present invention may become apparent in light of the above teachings. For example, any sensors providing the necessary sensor measurements can be used to construct the desired DPMs, and the invention can utilize any sensors that provide measurements according to equations (1), (3), (4), and (6). The block diagram of the cement production process is merely illustrative and not intended for limitation, and alternate cement production elements can be included or otherwise eliminated without departing from the scope of the invention. Although the equations were presented for units of tons or tons/hour, other units of measurement and/or time can be utilized to modify the equations accordingly.

Many additional changes in the details, materials, steps and arrangement of parts, herein described and illustrated to explain the nature of the invention, may be made by those skilled in the art within the principle and scope of the invention. Accordingly, it will be understood that the invention is not to be limited to the embodiments disclosed herein, may be practiced otherwise than specifically described, and is to be understood from the following claims, that are to be interpreted as broadly as allowed under the law.

What is claimed is:

1. A method for monitoring a cement production process having a kiln, comprising
computing clinker production at the kiln output,
computing the cost of clinker based on the computed clinker production, and,
displaying at least one of the clinker production and the cost of clinker as a function of time.

2. A method according to claim 1, wherein computing clinker production further comprises,
measuring feed to the kiln,
measuring dust loss from the kiln, and,
computing the difference between the measured feed to the kiln and the dust loss from the kiln.

3. A method according to claim 2, wherein measuring feed to a kiln further includes measuring raw meal input to a kiln.

4. A method according to claim 2, wherein measuring feed to a kiln further includes measuring slurry input to a kiln.

5. A method according to claim 1, wherein computing the cost of clinker based on the computed clinker production further comprises measuring at least one of a kiln coal feed rate and a kiln non-coal fuel feed rate.

6. A method according to claim 1, wherein computing the cost of clinker based on the computed clinker production further comprises computing a credit based on waste fuel.

7. A method according to claim 1, further comprising,
deriving a measure based on at least one of the computed clinker production and the computed cost of clinker, comparing the derived measure to a threshold, and, generating an alarm based on the comparison of the derived measure and the threshold.

8. A method for monitoring a cement processing operation, comprising
computing finish mill throughput,
computing cement cost based on the computed finish mill throughput, and,
displaying at least one of the finish mill throughput and the cement cost as a function of time.

9. A method according to claim 8, further comprising computing clinker production.

10. A method according to claim 9, further comprising computing the cost of clinker based on the computed clinker production.

11. A method according to claim 8, wherein computing finish mill throughput further comprises measuring an amount of clinker fed to the input of the finish mill.

12. A method according to claim 8, wherein computing cement cost based on the computed finish mill throughput further comprises measuring at least one of a gypsum feed rate, a clinker feed rate to the finish mill, and a grinding aide feed rate.

13. A method according to claim 8, further comprising,
deriving a measure based on at least one of the computed finish mill throughput and the computed cement cost,
comparing the derived measure to a threshold, and,
generating an alarm based on the comparison of the derived measure and the threshold.

14. A system for measuring the efficiency of a kiln in a production process, the system comprising,
at least one sensor to measure clinker production at the kiln output,
at least one sensor to measure at least one of a kiln coal feed rate and a kiln non-coal feed rate,
at least one processor module to accept the sensor outputs and process the sensor outputs, and, at least one display module to display at least one of the processed sensor outputs as a function of time.

15. A system according to claim 14, wherein the sensors include at least one of a temperature sensor, a heat sensor, an oxygen sensor, a carbon monoxide sensor, a cooling fan rotation sensor, a power sensor, an air temperature sensor, a clinker temperature sensor, a secondary air temperature sensor, a cooler vent temperature sensor, an oil flow sensor, a fan speed sensor, and a damper sensor.

16. A system for measuring the efficiency of a finish mill in a cement production process, comprising,
at least one sensor to measure the clinker input to the finish mill
at least one sensor to measure at least one of a clinker feed rate, gypsum feed rate, and grinding aide feed rate,
at least one processor module to accept the sensor outputs and process the sensor outputs, and,
at least one display module to display at least one of the processed sensor outputs as a function of time.

17. A system according to claim 16, further comprising a sensor to measure reject at the input to the finish mill.

18. A system according to claim 16, wherein the sensors include at least one of a temperature sensor, a power sensor, an energy sensor, and a water content sensor.

19. A control system for a cement production process having a kiln, comprising
at least one sensor to provide data related to feed to the kiln,
at least one sensor to provide data related to dust loss from the kiln, and, a control processor to receive the data from the feed sensors and the dust loss sensors, compute a dynamic performance measure based on the feed to the kiln and the dust loss from the kiln, and compare the dynamic performance measure to a threshold.

20 A control system according to claim 19, further comprising,
a display coupled to the data processing unit for displaying the dynamic performance measure.

21. A control system according to claim 19, wherein the control processor further includes instructions to cause the control processor to adjust the feed rate based on the dynamic performance measure.

22. A control system according to claim 19, wherein the at least one sensor to provide data related to the feed to the kiln further include at least one sensor to measure raw meal input to the kiln.

23. A control system according to claim 19, wherein the at least one sensor to provide data related to the feed to the kiln further includes at least one sensor to measure slurry input to the kiln.

24. A control system according to claim 19, further comprising at least one sensor to measure at least one of a kiln coal feed rate and a kiln non-coal feed rate.

26. A control system for cement processing, comprising,
at least one sensor to provide data related to finish mill throughput,
at least one sensor to provide data related to clinker production, at least one sensor to measure at least one of a gypsum feed rate, a clinker feed rate to the finish mill, and a grinding aide feed rate, and a control processor to collect data from the at least one finish mill sensor, the at least one clinker production sensor, and at least one of the gypsum feed rate sensor, clinker feed rate sensor, and grinding aide feed rate sensor, and compute a dynamic performance measure related based on the finish mill throughput and the clinker production.

27. A control system according to claim 26, wherein the control processor further includes instructions to compare the dynamic performance measure to a threshold.

28. A control system according to claim 26, further comprising, a display coupled to the data processing unit to display the dynamic performance measure.

29. A control system according to claim 26, wherein the control processor includes instructions to modify at least one of the gypsum feed rate, clinker feed rate, and grinding aide feed rate.
